(19) United States
(12) Patent Application Publication
(10) Pub. No.: US 2018/0079652 A1
(43) Pub. Date: Mar. 22, 2018

(54) METHOD FOR REDUCING FORCES (HOT FILL/RE-FILL)

(71) Applicant: Amminex Emissions Technology A/S, Søborg (DK)

(72) Inventors: Lasse Bjørchmar Thomsen, Kastrup (DK); Ulrich Joachim Quaade, Bagsværd (DK); Johnny Johansen, Københaven S (DK); Agata Bialy, Ølstykke (DK); Tue Johannessen, Glostrup (DK)

(21) Appl. No.: 15/564,530

(22) PCT Filed: Apr. 7, 2016
(86) PCT No.: PCT/EP2016/000573

§ 371 Date: Oct. 5, 2017

(30) Foreign Application Priority Data
Apr. 9, 2015 (EP) 15001018.9

(51) Int. Cl. C01C 1/00; B01J 20/04; B01J 20/34; F17C 11/00

(52) U.S. Cl. CPC C01C 1/006; B01J 20/046; F17C 11/00; B01J 20/3491; B01J 20/3433

(57) ABSTRACT

A method for controlling the magnitude of mechanical forces exerted by a solid ammonia storage material on walls of a container: determining a mechanical-strength limit of the container in terms of a hydraulic pressure P_{LIMIT} or force F_{LIMIT} under which the walls of container do not undergo plastic deformation, or deformation of more than 200% of deformation at the yield point; using a correlation between a temperature T_{SAT} for the ammonia saturation/resaturation process, and the hydraulic pressure P_{MAT}, or F_{MAT} generated by the storage material during saturation/resaturation, to identify a minimum temperature T_{SATMIN} where P_{MAT}, or F_{MAT} is kept below the limit for the mechanical strength by carrying out the saturation/resaturation process at the temperature T_{SAT} fulfilling the condition of T_{SAT}≧T_{SATMIN}.

### FIELD OF THE INVENTION

The present invention relates to ammonia storage in a solid ammonia storage material and, for example, to a method for controlling the magnitude of mechanical forces exerted by a solid ammonia storage material on walls of a container holding the storage material. The invention also relates to a method of designing a container for accommodating solid ammonia storage material, a container filled with a solid ammonia storage material, and the use of a correlation between a temperature for ammonia saturation/resaturation process of an ammonia storage material and the hydraulic pressure or equivalent mechanical force generated by the storage material during saturation/resaturation.

### BACKGROUND OF THE INVENTION

Anhydrous ammonia is a widely used chemical with many applications. One example is the use as reductant for selective catalytic reduction (SCR) of NOₓ in exhaust gas from combustion processes.

For most end-user applications, and in particular in automotive applications, the storage of ammonia as pure, pressurized anhydrous ammonia in a pressure vessel is too hazardous. A storage method involving absorption of molecular ammonia in a solid material kept in a closed metal container can circumvent the safety hazard and enable the use of gaseous ammonia in any mobile or de-central application. In emissions technology, the use of direct ammonia gas dosing from cartridges/containers holding solid storage materials gives much better DeNOx potential via SCR catalysts than the conventional use of urea dissolved in water (for example, 32.5% urea dissolved in water, marketed under the trade name AdBlue®)—in particular for vehicles driving in cities with relatively low exhaust temperature.

Metal ammine salts are materials capable of reversible ammonia absorption/desorption, which can be used as solid storage medium for ammonia (see e.g. WO 2006/012903 A2). The material is delivered in metal containers (or so-called cartridges) to be integrated in a specific and well-defined packaging or installation volume on a vehicle and then the ammonia is gradually released for NOx reduction (EP 2181963 A1).

When such cartridges holding metal ammine complexes are used on a vehicle, they gradually become depleted of ammonia and degassed salt material remain in the metal cartridge. Cartridges must be saturated (resaturated) with ammonia in order to be used again. One-time-use of such a unit is too expensive and not a sustainable solution.

An industrially relevant application requires therefore that the cartridge holding the ammonia storage material can be saturated/resaturated many times. Comparing with—as example—propane bottles for barbeques, a customer does not buy a new propane tank (e.g. 80 Euro price) each time—but rather buys a tank a first time and then gets a refilled unit subsequently (10-15 Euro price).

Metal ammine complexes have been studied in the past years and it has turned out to be a challenging class of material. It requires in some cases additives or internal metal foil structure to get the proper heat transfer and it is a known fact that the salt crystal lattice can expand by e.g. a factor of four when absorbing ammonia.

Saturation or resaturation of depleted ammonia storage material in a metal container cannot be done practically on the vehicle since it takes much more than just a few minutes to resaturate (removal of absorption heat by cooling may take several hours) and it requires anhydrous ammonia available next to the vehicle. Consequently, the depleted cartridge must be resaturated before next use. To minimize the cost for the end-user, the saturation/resaturation process must be efficient and, even more importantly, allow for the cartridge/unit to be used many times.

Like in the case of recharging of electrical batteries, an important aspect of a process for cartridge refilling is avoiding degradation of the unit that over time would render the cartridge unusable. An observed physical effect that has a big impact on the cartridge durability is the expansion of the salt during saturation/resaturation. This expansion, which is also mentioned in WO 2010/025947 A1, leads to high mechanical forces which in turn may deform the metal wall of the cartridges or damage an internal structure for improving the heat transfer. Over several refilling/degassing cycles the shape or performance of the cartridge may degrade to a level where the cartridge will become unusable and the deformation will lead to no longer fitting in the volume or installation space intended for the cartridge. These expansion forces may to some extent be mitigated by making the cartridge wall very thick or significantly reducing the targeted storage density of the material (e.g. to less than 50% or 75% of the theoretical max. density). Thick-walled cartridges become both expensive and heavy while a significant reduction in the targeted storage density (reduced salt loading per unit volume) makes the cartridge industrially unattractive as an ammonia carrying unit because of poor utilization of the overall volume on the vehicle.

Consequently, a solution is needed that enables a combination of three industrially important parameters: high storage density, low weight and high durability (low cost-of-ownership). Unless all three are proven for an ammonia storage product, it is difficult to find a relevant place on the market that allows capturing the huge environmental benefits of being able to dose ammonia gas directly for optimal SCR NOx reduction.

### SUMMARY OF THE INVENTION

A method is provided for controlling the magnitude of mechanical forces exerted by a solid ammonia storage material on walls of a container holding the storage material inside its interior volume when the storage material is undergoing saturation/resaturation with ammonia inside said storage container. The method comprises:
a. determining a limit for the mechanical strength of the container in terms of a hydraulic pressure, hereinafter P_{LIMIT}, or a hydraulic force, hereinafter F_{LIMIT}, in its interior volume under which the walls of container do not undergo plastic deformation, or do not undergo deformation of more than 110%, 120%, 150%, or 200% of a deformation at a yield point of the container walls;
b. using a given correlation between
   i. a temperature for ammonia saturation/resaturation process of the storage material, hereinafter T_{SAT}, and
   ii. the hydraulic pressure P_{MAT}, or equivalent mechanical force F_{MAT} generated by the storage material during saturation/resaturation at said temperature T_{SAT},
   to identify a minimum temperature, hereinafter T_{SATMIN}, of the saturation/resaturation process where P_{MAT}, or F_{MAT}, exerted by the storage material is kept below the limit for the mechanical strength in terms of P_{LIMIT}, or F_{LIMIT}, of the container by carrying out the saturation/resaturation process at the temperature T_{SAT} fulfilling the condition of T_{SAT}≧T_{SATMIN}.

According to another aspect a method is provided of designing a container for accommodating solid ammonia storage material where a process temperature for ammonia saturation/resaturation T_{SAT} and a target density of the storage material, D_{MAT} are fixed, and the outcome of the design method is a container design capable of withstanding a resulting exerted pressure from the material, P_{MAT}, or force F_{MAT}, upon ammonia saturation/resaturation. The method comprises using a known relation between D_{MAT}, T_{SAT}, and P_{MAT}, or F_{MAT}, to establish a value of P_{MAT}, or F_{MAT}, and use this value for the design of the container such that its mechanical strength measured in terms of a hydraulic-limit parameter P_{LIMIT}, or F_{LIMIT}, under which walls of the container do not undergo plastic deformation, or do not undergo deformation of more than 110%, 120%, 150%, or 200% of a deformation at a yield point of the container walls, is equal to or exceeds the value of P_{MAT}, or F_{MAT}.

According to another aspect a container is provided filled with a solid ammonia storage material with a storage density, D_{MAT}, capable of desorbing and absorbing/reabsorbing ammonia, said container having a mechanical strength corresponding to a limit-pressure parameter, P_{LIMIT}, or limit-force parameter F_{LIMIT}, at which pressure, or force, inside the container the container does not undergo plastic deformation, or do not undergo deformation of more than 110%, 120%, 150%, or 200% of a deformation at a yield point of the container walls. The storage material in the container is filled with ammonia by a saturation/re-saturation process in which the saturation/resaturation of the storage material is performed with the storage material inside the container at a process temperature, T_{SAT}, fulfilling the condition T_{SAT}≧T_{SATMIN}. T_{SATMIN} is a minimum temperature of the saturation/resaturation process where P_{MAT}, or F_{MAT}, exerted by the storage material is kept below the limit for the mechanical strength in terms of P_{LIMIT}, or F_{LIMIT}, of the container.

Still another aspect pertains to the use of a correlation between a temperature for ammonia saturation/resaturation process, T_{SAT}, of an ammonia storage material and the hydraulic pressure, P_{MAT}, or equivalent mechanical force, F_{MAT}, generated by the storage material during saturation/resaturation at said temperature T_{SAT}, to influence the level of force or pressure exerted by the storage material by carrying out the saturation/resaturation at a temperature where the resulting pressure, P_{MAT}, or force, F_{MAT}, exerted by the storage material is kept below a limit under which the container does not undergo plastic deformation, or does not undergo deformation of more than 110%, 120%, 150%, or 200% of a deformation at a yield point of the container walls.

Other features of the invention presented herein are inherent in the methods and products disclosed or will become apparent to those skilled in the art from the following detailed description of embodiments and its accompanying drawings.

### General Description, Also of Optional Embodiments of the Invention

It is noted that pressure and force are linked in the normal mechanical way; i.e. pressure is force exerted per unit area.

It has been discovered that the forces created by crystal expansion and thus the mechanical forces of metal ammine complexes while absorbing/reabsorbing ammonia can be described conceptually as a hydraulic pressure exerted by a fluid. More importantly—and the key to the current invention—it has been discovered that this mechanical force, F_{MAT}, or the equivalent hydraulic pressure, P_{MAT}, is strongly correlated with the temperature level of the ammonia storage material during its saturation or resaturation. It is observed that when saturation/resaturation temperature is increased then P_{MAT} is reduced.

In addition, there is link between the forces (or pressure) and the density of material, D_{MAT}, in the unit holding or confining the ammonia storage material. An increase in density—all other parameters kept identical—leads to a potential for higher force.

Although a conclusive scientific explanation is not yet available, a qualitative reasoning behind the discovery of the present invention is the following: Materials such as butter are very stiff at low temperature but become softer when the temperature is increased. When the material is softer it is difficult to have long-distance forces created by the material. If a fork is pushed towards soft (warm) butter, it enters the butter relatively easily. If the butter is very cold, the fork can hardly enter the butter and the push on the fork towards the butter rather results in moving the butter. This analogy can be used for explaining the present discovery. When the material is warm, the local expansion forces of the crystal structure when it absorbs ammonia are not transferred over long length scale (centimeters) but rather dissipated locally in the material at much smaller length scale. With a stiffer material—i.e. at lower temperatures—the forces can have long-scale effects and thereby exert the forces (or a corresponding pressure) at a high level on the walls of the container.

In the present description, this aspect is utilized in an innovative and constructive manner to achieve the target of the invention: a robust, durable product having attractive properties and cost for the customer.

It is noticed from the results shown from the present invention that suitable levels of reduced material forces (pressure) are typically seen at saturation temperatures, T_{SAT}, above room temperature. Since the resaturation (or saturation) process needs active cooling in order to make a fast and efficient saturation process, one would normally use the approach of “as cold as possible” to speed up the refilling process. Contrary to this intuitive approach, the method of the present invention has its most attractive features when cooling is done with warm fluid.

In the present description this aspect is applied to achieve a combination of a durable ammonia storage cartridge with attractive properties and a cost-effective refill process.

When the ammonia storage material is undergoing saturation/resaturation with ammonia inside said storage container, the method comprises reducing expansion forces of solid ammonia storage metal ammine complexes capable of reversibly absorbing and desorbing ammonia when confined in one or more metal containers, wherein said material, when undergoing saturation or resaturation with ammonia, is kept at process conditions that reduces the magnitude of the expansion forces to a level that eliminates or reduces deformation of the metal container itself that encapsulates the material.

In some embodiments, the determination of T_{SATMIN} uses the correlation between T_{SAT} and P_{MAT}, or F_{MAT}, and also includes a correlation with the density of the ammonia storage material D_{MAT} where D_{MAT} is calculated based on the ammonia storage material being fully saturated with ammonia.

In some embodiments a liquid cooling media is used during saturation/restauration, and there is an upper limit on T_{SAT}, for practical reasons, defined by the boiling point of the cooling media (T_{CMBP}, cooling media boiling point) such that T_{CMBP}≧T_{SAT}≧T_{SATMIN}. For example, T_{CMBP} is about 100° C.

In other embodiments the ammonia storage material is cooled during the saturation/resaturation process by a gaseous cooling media. The saturation/resaturation process at the temperature T_{SAT} fulfills the condition T_{CMBP}≧T_{SAT}≧T_{SATMIN}, where T_{CMBP} is an upper limit on the temperature at which the saturation/resaturation process is performed cooled by the gaseous cooling media. For example, also in that case T_{CMBP} may be about 100° C.

In some embodiments the method is based on a mechanical strength (P_{LIMIT}, F_{LIMIT}) being derived from official legislation targets, such as the target included in the United Nations standardization document ST/SG/AC.10/C.3/88, 12 Dec. 2013, “Report of the Sub-Committee of Experts on the Transport of Dangerous Goods on its forty-fourth session”, Chapter 3.3, according to which each receptacle containing adsorbed or absorbed ammonia shall be able to withstand the pressure generated at 85° C. with a volumetric expansion no greater than 0.1%, wherein the pressure at a temperature of 85° C. is less than 12 bar. Hence, in some of these embodiments the ammonia storage container has a mechanical strength which enables the container to withstand the pressure generated by desorbed ammonia at 85° C. with a volumetric expansion no greater than 0.1 volume-%.

In some embodiments, P_{LIMIT}, or F_{LIMIT}, and subsequently T_{SATMIN}, are determined from:
a. having an existing container design available,
b. knowing from the existing design the value of P_{LIMIT}, or F_{LIMIT}, or using (i) standard mechanical engineering practice, (i) hydraulic pressure measurements, or (iii) mechanical simulations to identity the value of P_{LIMIT}, or F_{LIMIT},
c. using the known or identified P_{LIMIT}, or F_{LIMIT}, to determine the loading density D_{MAT} and saturation/resaturation condition T_{SAT}≧T_{SATMIN}, or T_{CMBP}≧T_{SAT}≧T_{SATMIN}, to prevent P_{MAT}, or F_{MAT}, from exceeding P_{LIMIT}, or F_{LIMIT}.

In some embodiments the procedure of determining T_{SATMIN} includes an experimental mapping procedure in which experimental data points are obtained to establish an empirical relationship or correlation between the dependent variable P_{MAT}, and the independent variable T_{SAT}. The mapping procedure comprises:
a. preparing at least one sample of ammonia storage material;
b. carrying out ammonia desorption and resaturation experiments in a sample holder capable of measuring P_{MAT} exerted by the material on the walls of the sample holder when it the material is undergoing saturation/re-saturation, said procedure being carried out at different temperature levels T_{SAT};
c. using the experimental data points to generate a function or interpolation formula P_{MAT}=f(T_{SAT}), or F_{MAT}=f(T_{SAT}).

Alternatively, in some embodiments in which different densities D_{MAT} are taken into account, the procedure of determining T_{SATMIN} includes an experimental mapping procedure in which experimental data points are obtained to establish an empirical relationship or correlation between the dependent variable P_{MAT}, or F_{MAT}, and the independent variables T_{SAT} and D_{MAT}. The mapping procedure comprises:
a. preparing at least one sample of ammonia storage material with known density D_{MAT};
b. carrying out ammonia desorption and resaturation experiments in a sample holder capable of measuring P_{MAT} exerted by the material on the walls of the sample holder when it the material is undergoing saturation/re-saturation, said procedure being carried out at different temperature levels T_{SAT};
c. using the experimental data points to generate a function or interpolation formula P_{MAT}=f(T_{SAT}, D_{MAT}), or F_{MAT}=f(T_{SAT}, D_{MAT}) in the case where samples with different densities D_{MAT} are measured.

In a variant of the embodiments mentioned above the procedure of determining T_{SATMIN} is done by creating the relationship between P_{MAT}, or F_{MAT}, and T_{SAT}, and optionally D_{MAT} via computer simulations using parameters describing the ammonia storage material, ammonia itself and the material in saturated form. Said parameters describe the state of the material in saturated and unsaturated form, the influence of these parameters as a function of temperature and with input of density of the material the model can estimate or predict the level of the dependant variable, P_{MAT}, (or F_{MAT}) based on the input variables like density, material parameters and saturation temperature. Such a computer model can be structured in different ways and an example is to use traditional finite element method (FEM) simulation.

It may be advantageous to increase the temperature T_{SAT} significantly above T_{SATMIN} to make up for a relatively weak cartridge design, or where a high density is attractive, or in the case where the duration of the saturation process is of less or no importance.

Even if very high reduction of forces can be obtained at temperatures above 60-80° C. it may be advantageous to keep a lower temperature (closer to T_{SATMIN}) where the reduction of forces is sufficient thereby allowing a better thermal gradient between storage material absorbing ammonia when subjected to the pressure P_{SAT} to decrease the process duration. Typically, the ammonia gas pressure, P_{SAT}, needs to be at least high enough to give a gradient corresponding to at least 10° C. difference relative to the equilibrium temperature of the storage material when exposed to the pressure P_{SAT}. Example: At 55° C. the equilibrium desorption pressure of ammonia from the solid storage material is approx. 2.5 bar (for SrCl₂) and using P_{SAT}=2.5 bar would give an absorption rate equal to zero since there is no driving force for absorption and thereby no heat to be removed.

It is also considered by another aspect of the present invention to have a method where the process condition, T_{SAT}, and target density of the storage material, D_{MAT}, are initially fixed, e.g. by existing hardware requirements, and the outcome of this other aspect is a container design capable of withstanding the resulting exerted pressure, or force, from the material, P_{MAT}, or F_{MAT}, upon ammonia saturation/resaturation:
a. knowing the temperature T_{SAT} and the target density of the storage material, D_{MAT};
b. using a known relation between D_{MAT}, T_{SAT}, and P_{MAT}, or F_{MAT}, to establish a value of P_{MAT}, or F_{MAT}, and use this value for the design of the container such that its mechanical strength measured in terms of a hydraulic-limit parameter P_{LIMIT}, or F_{LIMIT}, under which walls of the container do not undergo plastic deformation, or do not undergo deformation of more than 110%, 120%, 150%, or 200% of the deformation at the yield point of the container walls, is equal to or exceeds the value of P_{MAT}, or F_{MAT}.

The various features and optional variants described above in connection with the method of controlling the mechanical forces exerted by the ammonia storage material also apply to this other aspect, i.e. the method of designing a container for accommodating solid ammonia storage material.

The present invention also includes an aspect of a container for storing a solid ammonia storage material with a storage density, D_{MAT}, capable of desorbing and (re)absorbing ammonia, said container having a mechanical strength corresponding to a limit-pressure parameter, P_{LIMIT}, or limit-force parameter F_{LIMIT}, at which pressure, or force, inside the container the container does not undergo plastic deformation, or does not undergo deformation of more than 110%, 120%, 150%, or 200% of the deformation at the yield point of the container walls. The storage material in the container has been filled with ammonia by a saturation/re-saturation process in which the saturation/resaturation of the storage material has been performed with the storage material inside the container at a process temperature, T_{SAT}, fulfilling the condition T_{SAT}≧T_{SATMIN}, where T_{SATMIN} is the minimum temperature of a saturation/resaturation process where P_{MAT}, or F_{MAT}, exerted by the storage material is kept below the limit for the mechanical strength in terms of P_{LIMIT}, or F_{LIMIT}, of the container.

The various features and optional variants described above in connection with the methods of controlling the mechanical forces exerted by the ammonia storage material and of designing a container also apply to this aspect, i.e. the container filled with a solid ammonia storage material.

Finally, the scope of the invention is also the use of a correlation or relation between a temperature for ammonia saturation/resaturation process, T_{SAT}, and—optionally—also the storage density, D_{MAT}, of an ammonia storage material, and the hydraulic pressure, P_{MAT}, or equivalent mechanical force, F_{MAT}, generated by the storage material during saturation/resaturation at said temperature T_{SAT}, for the design or manufacture of containers storing a material capable of ammonia absorption, more specifically, to influence the level of force or pressure exerted by the storage material by carrying out the saturation/resaturation at a temperature where the resulting pressure, P_{MAT}, or force, F_{MAT}, exerted by the storage material is kept below a limit under which the container does not undergo plastic deformation, or does not undergo deformation of more than 110%, 120%, 150%, or 200% of the deformation at the yield point of the container walls.

It is noted that the methods described herein are also advantageous for preparing the initial product, i.e. a container/cartridge which is charged with ammonia by in-situ saturation of storage material. By avoiding all the complicated process conditions mentioned in WO 2010/025947 A1, the present invention enables simplified production of an in-situ saturated cartridge where not-yet-saturated storage material is placed inside the cartridge prior to a first saturation and is saturated for the first time inside the (metal) cartridge shell.

### BRIEF DESCRIPTION OF THE DRAWINGS

Exemplary embodiments are now described, also with reference to the accompanying drawings, wherein

FIG. 1 shows the material expansion pressure, P_{MAT}, during ammonia saturation plotted against the cooling medium temperature, T_{SAT};

FIG. 2 shows data points and a resulting model correlation between P_{MAT} and different combinations of T_{SAT} and D_{MAT};

FIG. 3 shows the normalized deformation of an ammonia storage container versus the number of resaturation cycles;

FIG. 4 shows an illustration of elastic and plastic deformation;

FIG. 5 shows an example of a process for resaturation storage material with ammonia inside containers with appropriate control of T_{SAT}:

FIG. 6 shows an example of a computer-simulation method to establish a relationship between P_{MAT}, or F_{MAT}, and T_{SAT} and, if applicable, D_{MAT}, to determine T_{SATMIN}.

### DESCRIPTION OF EXAMPLES

The temperature level, T_{SAT}, is determined by the temperature of the cooling media since the cartridges generate heat when ammonia is absorbing. Choosing different cooling media is possible while still fulfilling the T_{SATMIN}.

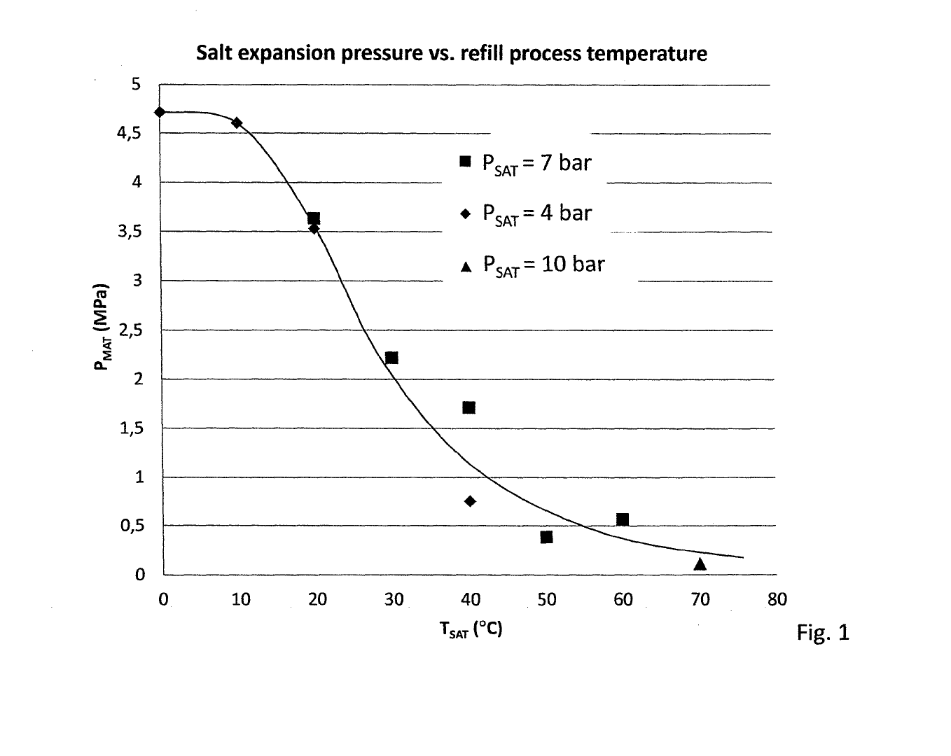

FIG. 1 shows the material expansion pressure, P_{MAT}, during ammonia saturation plotted against the cooling medium temperature, T_{SAT}, during saturation of a material sample kept in a container capable of monitoring the expansion pressure. The mechanical pressure exerted by the material depends strongly on temperature, T_{SAT}. The measurements are done for same sample but varying ammonia gas saturation pressures P_{SAT}. This shows that the effect of P_{MAT} is strongly an effect of temperature and not the ammonia gas pressure.

Hence, FIG. 1 shows data points and an empirical correlation (based on the data points) between the temperature T_{SAT} for the ammonia saturation/resaturation process of the storage material, and the hydraulic pressure P_{MAT} (the equivalent mechanical force F_{MAT} could be used in an equivalent manner) generated by the storage material during saturation/resaturation at said temperature T_{SAT}.

With a given limit for the mechanical strength of the given cartridge in terms of P_{LIMIT}, or FLINT, under which the walls of cartridge do not undergo plastic deformation, or do not undergo deformation of more than 110%, 120%, 150%, or 200% of the deformation at the yield point of the container walls, a correlation of this type is used to identify a minimum temperature T_{SATMIN} of the saturation/resaturation process where P_{MAT}, or F_{MAT}, exerted by the storage material is kept below the limit for the mechanical strength, of the cartridge. Having found T_{SATMIN} the saturation/resaturation process is carried out at a temperature T_{SAT} fulfilling the condition T_{SAT}≧T_{SATMIN}.

Alternatively, the temperature T_{SAT} at which the saturation/resaturation is performed may be predetermined and fixed. In this case the correlation of the type shown in FIG. 1 and described above is used for the design of a cartridge for the solid ammonia storage material capable of withstanding a resulting exerted pressure from the material, P_{MAT}, or force F_{MAT}. The relation between T_{SAT}, and P_{MAT}, or F_{MAT}, is used to find the value of P_{MAT}, or F_{MAT}, that corresponds to the given value of T_{SAT}. This found value of P_{MAT}, or F_{MAT} is then used for the design of the cartridge such that the cartridge's mechanical strength measured in terms of a hydraulic-limit parameter P_{LIMIT}, or F_{LIMIT}, under which walls of the cartridge do not undergo plastic deformation, or do not undergo deformation of more than 110%, 120%, 150%, or 200% of the deformation at the yield point of the container walls, is equal to or exceeds the value of P_{MAT}, or F_{MAT}.

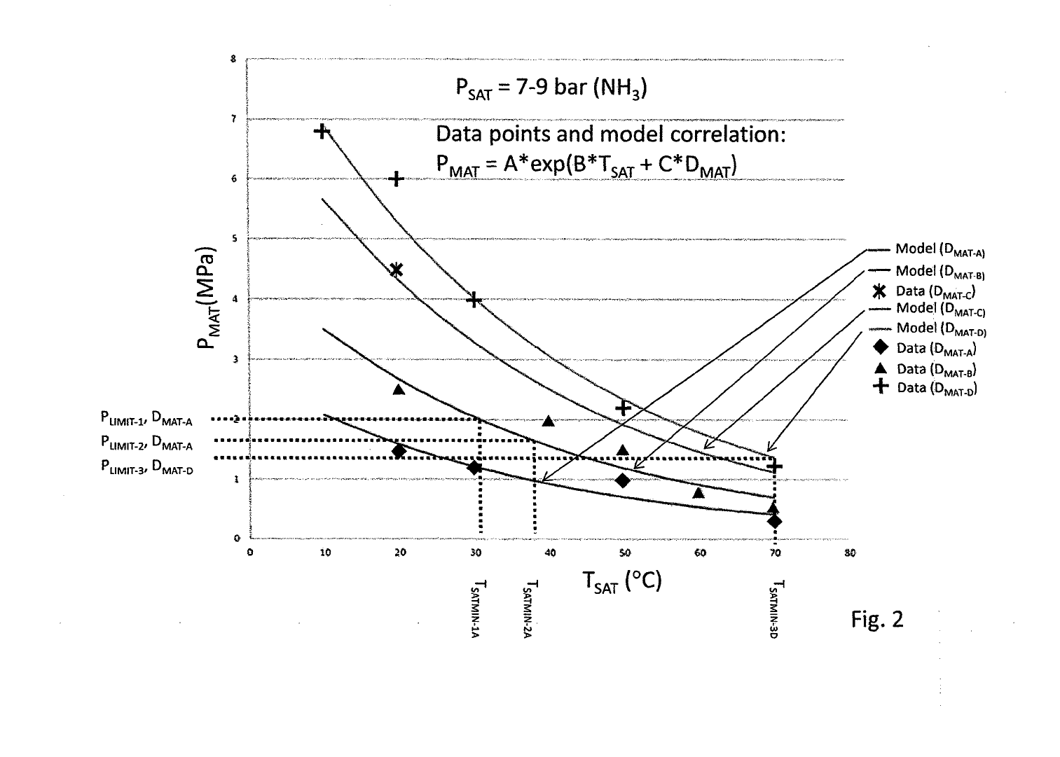

FIG. 2 shows data points and a resulting empirical model correlation between P_{MAT} and T_{SAT} similar to FIG. 1, however for different ammonia-storage-material densities D_{MAT}, with D_{MAT} being a parameter in the representation of P_{MAT} as a function of T_{SAT} of FIG. 2 for four different levels of D_{MAT}, labeled as “A” to “D” g/cm³, B≈1.13 g/cm³, C≈1.25 g/cm³ and g/cm³). The ammonia storage material in degassed form is SrCl₂, and Sr(NH₃)₈Cl₂ in fully saturated form. As a reference point, the density is calculated when the material is in its saturated form. For each density level there is a strong correlation with T_{SAT}. The model equation best describing the experimental model data done on small material samples is of the form P_{MAT}=A*exp(B*T_{SAT}+C*D_{MAT}), but any kind of mathematical representation giving a good data representation is envisaged. Three illustrations, labelled as P_{LIMIT-1}, P_{LIMIT-2}, and P_{LIMIT-3}, are made, where a certain P_{LIMIT-3} is linked to another density D_{MAT} than that of P_{LIMIT-1} and P_{LIMIT-2}, and as a result the required saturation temperature, T_{SATMIN}, is located on the X-axis. To ensure that P_{MAT} is not exceeding P_{LIMIT} it can be seen that T_{SAT} has to be equal to—or larger—than T_{SATMIN}, i.e. T_{SAT}≧T_{SATMIN}.

With a given limit for the mechanical strength of the given cartridge in terms of P_{LIMIT}, or F_{LIMIT}, under which the walls of cartridge do not undergo plastic deformation, or do not undergo deformation of more than 110%, 120%, 150%, or 200% of the deformation at the yield point of the container walls, and a given target density D_{MAT} of ammonia-storage material in the cartridge, a correlation of this type is used to identify a minimum temperature T_{SATMIN} of the saturation/resaturation process where P_{MAT}, or F_{MAT}, exerted by the storage material is kept below the limit for the mechanical strength, of the cartridge. Having found T_{SATMIN} for the given P_{LIMIT} and D_{MAT} the saturation/resaturation process is carried out at a temperature T_{SAT} fulfilling the condition T_{SAT}≧T_{SATMIN}.

Alternatively, the temperature T_{SAT} at which method is performed may be predetermined and fixed. If one of various available target densities D_{MAT} of ammonia-storage material in the cartridge is also given, the correlation of the type shown in FIG. 2 and described above is used for the design of a cartridge for the solid ammonia storage material capable of withstanding a resulting exerted pressure from the material, P_{MAT}, or force F_{MAT}. The relation between T_{SAT}, D_{MAT}, and P_{MAT}, or F_{MAT}, is used to find the value of P_{MAT}, or F_{MAT}, that corresponds to the given values of T_{SAT} and D_{MAT}. The determined value of P_{MAT}, or F_{MAT}, is then used for the design of the cartridge such that the cartridge's mechanical strength measured in terms of a hydraulic-limit parameter P_{LIMIT}, or F_{LIMIT}, under which walls of the cartridge do not undergo plastic deformation, or do not undergo deformation of more than 110%, 120%, 150%, or 200% of the deformation at the yield point of the container walls, is equal to or exceeds the value of P_{MAT}, or F_{MAT}.

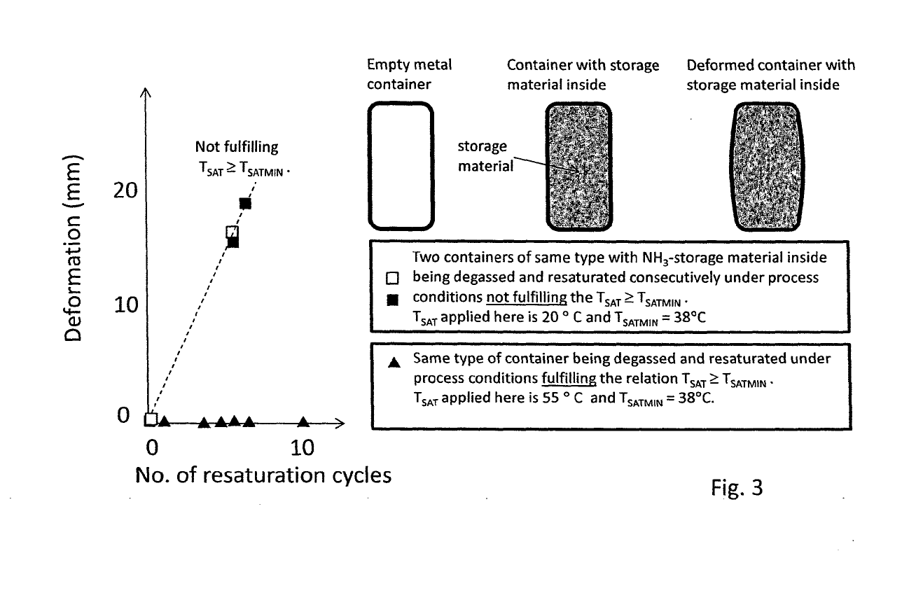

FIG. 3 shows proof of the features of the present invention. Data are shown for cartridges undergoing consecutive cycles of NH₃-degassing and NH₃-resaturation. In this example, the tested cartridges are cylindrical and made of aluminum. In the specific design used in these cartridges, the end-caps represent the weakest point and are made to be able to withstand at least 1.7 MPa gas pressure without plastic deformation (i.e. P_{LIMIT}=1.7 MPa), corresponding to P_{LIMIT-2} of FIG. 2. The ammonia-storage-material density is approx. 1.13 g/cm³ in this example, which is supposed to correspond to D_{MAT-A} in FIG. 2. Then it can be seen from FIG. 2 that the analysis gives T_{SATMIN} at approx. 38° C. In the conventional resaturation process the ammonia gas pressure was approx. 7-8 bar, and a cooling media of water was kept at about 20 C (T_{SAT} 20° C.) to have fast cooling by removal of ammonia absorption heat from the cartridge, i.e. below T_{SATMIN} 38° C.). It is observed from the testing that even when these units are consistently operated at much lower pressure than P_{LIMIT}=1.7 MPa (desorption pressure for degassing: 2-4 bar; corresponding to 0.2-0.4 MPa; saturation pressure=7-8 bar, corresponding to 0.7-0.8 MPa), the cartridge deforms inelastically even after only a few saturation cycles, and the cartridges can no longer be used even before reaching, e.g., ten refills since they do no longer fit in the installation volume. This is shown for two different units of same type.

Applying the method of the present invention to this example (viz. to a cartridge of the same type filled with the same storage material with the same density, i.e. the same T_{SATMIN}) the following has been found: The same test has been carried out, however with the cooling media kept at about 55 C (T_{SAT} 55° C.), i.e. above T_{SATMIN} 38° C.). The lower part of the graph on FIG. 3 shows degassing/refill cycles when the process and design constraint according to the method of the present invention is fulfilled. It is seen that fulfilling the saturation process condition (triangles) eliminates the massive plastic deformation observed after few cycles with the conventional method (the hollow and filled square points).

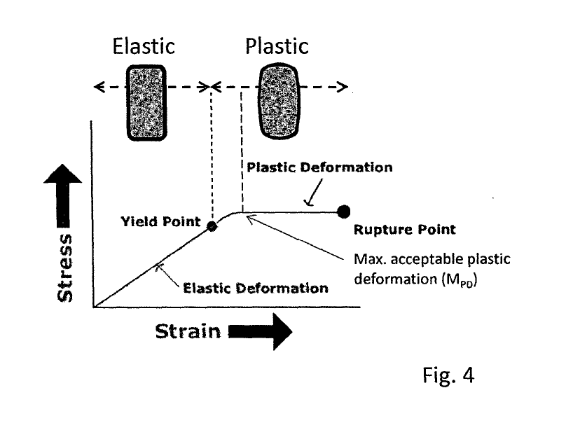

FIG. 4 shows an exemplary illustration of the relationship between strain (deformation) and stress on a metal member, e.g. a container. Plastic deformation (also referred to as “inelastic deformation”) of a container occurs when the stress created by the material gives a strain on the container wall that exceeds the level at the so-called yield point: The material deforms (strains) because of the stress (created by F_{MAT}, or P_{MAT}). When T_{SAT}>T_{SATMIN}, the stress created by the material is reduced and the container remains in the area of elastic deformation.

As schematically shown in FIG. 4, in the elastic-deformation regime the relation between stress and strain is nearly linear while in the plastic-deformation regime the strain-stress relation becomes nearly flat (meaning that the material continues to deform even if the stress is not increased). The transition between the linear and the flat relation typically has a continuously changing slope; i.e. the change is slope is not abrupt but extends over a finite strain range. The “yield point” is defined to be the stress at which a material begins to deform plastically; more specifically, the yield point is typically just before the transition from the linear to the flat part of the relation (when looking into the direction of increasing strain).

In some embodiments described herein the limit for the mechanical strength of the container in terms of the pressure, PUNT, or the force, F_{LIMIT}, is defined to be the pressure, or the force, in the container's interior volume under which the walls of container do not undergo plastic deformation; i.e. there is no deformation beyond the yield point.

In other embodiments, however, a small degree of plastic deformation is acceptable; i.e. a strain beyond the yield point in the transition to the flat plastic-deformation regime before it becomes completely flat. In these embodiments the mechanical strength of the container in terms of the pressure, P_{LIMIT}, or the force, F_{LIMIT}, is defined to be the pressure, or force, that causes no deformation beyond a point in the transition region of the stress-strain diagram which is referred to as “maximum acceptable plastic deformation”, or “MPD”. The point MPD is defined as the maximum degree of plastic deformation that is acceptable for a certain container after which is does no longer fit into the physical application for which it is intended. Ideally, there is no plastic deformation (as indicated in the pervious paragraph) but in some special circumstances a minor degree of plastic deformation can be accepted; in such cases the parameter MPD can be 110, 120, 150, or 200% of the strain (=deformation) at the yield point. For example, if a sample container of diameter 100 mm can elastically deform by 0.5 mm just below the yield point (which means that it would there still return to normal shape), then MPD in this case at a strain of 200% of the strain at the yield point would be at maximum 1 mm, and the resulting maximum diameter would be 101 mm.

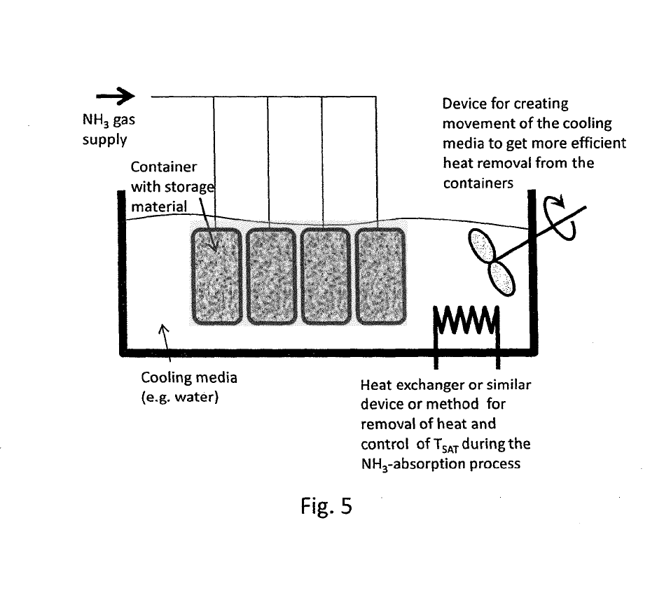

FIG. 5 shows an example of resaturation of a plurality of containers filled inside with storage ammonia material of the sort described above. The storage containers are immersed in a trough filled with cooling media (e.g. cold water), and are thus cooled by the cooling media. The temperature of the cooling media is controlled with a suitable device for control of the temperature of the media to reach a targeted saturation temperature T_{SAT}, e.g. a sensor for measuring the cooling-media temperature and a feed-back controller comparing the measured temperature with a target temperature and adjusting the temperature, or the flow, of the cooling media to counteract any difference between the measured and the target temperature. Common methods for creating movement of the cooling media to increase heat transfer from the container undergoing saturation can be applied, such as actively creating circulation of the cooling media in the trough by means of a pump or propeller. Ammonia is supplied as pressurized gas to the inside of the storage containers.

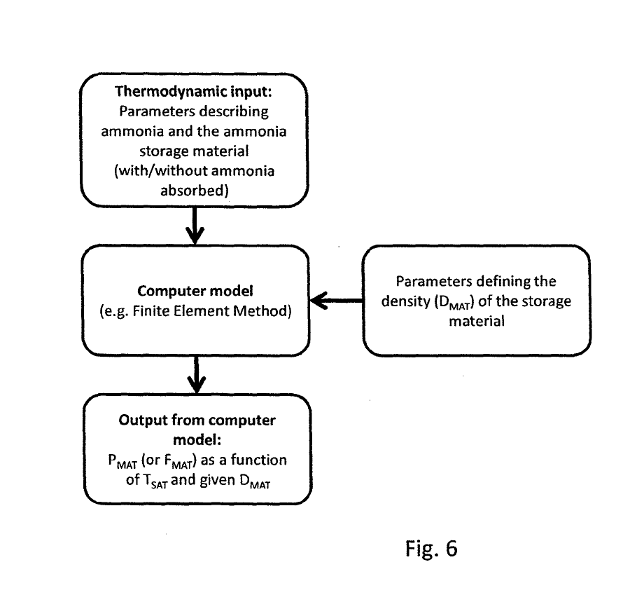

FIG. 6 shows a diagram of a simulation method to estimate or predict the relationship between T_{SAT}, D_{MAT} and the resulting pressure P_{MAT} (or F_{MAT}). Relevant parameters describing ammonia and the ammonia storage material (with/without ammonia absorbed), referred to as “Thermodynamic input”, and independent variables as well as the density, D_{MAT} of the ammonia storage material are fed to a computer model such as a Finite Element Method (FEM) simulation. For example, the computer model outputs P_{MAT} (or F_{MAT}) as a function of T_{SAT} and given D_{MAT}. This enables a minimum temperature T_{SATMIN} to be identified of the saturation/resaturation process where P_{MAT} (or F_{MAT}) exerted by the storage material is kept below the limit for the mechanical strength in terms of P_{LIMIT}, or F_{LIMIT}, of the container.

### FURTHER EXAMPLES

### Example 1: Procedure for Determining Forces from Saturation at Various Temperatures, and Finding a Minimum Saturation Temperature T_{SATMIN} for a Given Cartridge

In order to determine the relation between temperature, material density and saturation forces from ammonia storage material several experiments were conducted following a general procedure:

A predetermined mass of dry SrCl₂ powder was loaded in a reactor volume, which to was then closed. The mass of SrCl₂ was determined to yield a certain density, D_{MAT}, after saturation of SrCl₂ with ammonia. It was determined by multiplying the density by the volume of the reactor and dividing by the molar mass of fully saturated Sr(NH₃)₈Cl₂ and multiplying by the molar mass of SrCl₂.

The closed-off reactor was evacuated to remove ambient air and then subjected to a pressure of ammonia gas. The uptake of ammonia was followed by weighing the reactor and it was in this way ensured that the SrCl₂ was completely saturated by ammonia. During the uptake the force of the saturating SrCl₂ acting one end of the reactor was measured using a load cell. The temperature of the reactor walls were actively controlled using Peltier-elements.

After complete saturation the reactor was heated and the pressure at the outlet fixed to just above ambient pressure to degas ammonia from the reactor. The material was degassed for a fixed time before a pressure of ammonia was applied again to resaturate the material. In this way a sample could be recycled several times and the force measurement could be conducted for several temperature points.

To create the full map of the force for various temperatures and densities the reactor was loaded several times with various mass of SrCl₂ each cycled at various temperature points.

This procedure could be made for any relevant material capable of absorbing ammonia reversibly. Other examples of suitable ammonia storage materials are CaCl₂, BaCl₂ or any other metal ammine complex in pure form or as a mixture of salts. The typical formula for metal ammine complexes is: M(NH₃)_{X}H_{Y} where M is a metal ion, X is the coordination number for ammonia (from 0 up to 8 or even 12 in some salts), H is a halide (e.g. chloride ion) and Y is the number of halide ions in the complex. In saturated form the SrCl₂ and CaCl₂ salts absorb 8 ammonia molecules (Sr(NH₃)₈Cl₂ or Ca(NH₃)₈Cl₂.

With a given limit for the mechanical strength of the given cartridge in terms of P_{LIMIT}, or F_{LIMIT}, under which the walls of cartridge do not undergo plastic deformation, or do not undergo deformation of more than 110%, 120%, 150%, or 200% of the deformation at the yield point of the container walls, and a given target density D_{MAT} of ammonia-storage material in the cartridge, a relation of this type is used to identify a minimum temperature T_{SATMIN} of the saturation/resaturation process where P_{MAT}, or F_{MAT}, exerted by the storage material is kept below the limit for the mechanical strength, of the cartridge. Having found T_{SATMIN} for the given P_{LIMIT} and D_{MAT} the saturation/resaturation process is carried out at a temperature T_{SAT} fulfilling the condition T_{SAT}≧T_{SATMIN}.

### Example 2: Finding a Metal Wall Thickness Based on a Fixed Saturation, Temperature, and Storage-Material Density

A refill process has been established to refill cartridges at a temperature of 20° C. The ammonia storage material density given is 1175 g/cm³, which gives a material pressure P_{MAT}=3.2 MPa. The cartridge is cylindrical, with an outer diameter of 178 mm due to requirements of available space on certain vehicles on the market. It is decided to make the cartridge from a deep-drawn aluminum-alloy casing. After deep-drawing, the aluminum alloy has a yield strength of 170 MPa; the “yield strength”, or “yield point” is defined to be the stress at which a material begins to deform plastically. Prior to the yield point the material will deform elastically and will return to its original shape when the applied stress is removed. Once the yield point is passed, some fraction of the deformation will be permanent and non-reversible.

The minimum shell thickness of the cylinder can now be determined by the thin-walled assumption:

$$t = \frac{\sqrt{\frac{{Pd}^{2}}{σ} + {d}^{2}} - d}{2} = \frac{\sqrt{\frac{3.2 MPa \cdot {( 178 mm )}^{2}}{170 MPa} + {( 178 mm )}^{2}} - 178 mm}{2} = 0.83 mm$$

### Example 3

Given a certain design pressure and design temperature, the allowable stress (from vessel material) and required vessel radius (from volume), a common approach is the design by a rule method, following design rules such as the ASME Boiler and Pressure Vessel Code; ASME Section VIII Division 1.

The ASME design code gives for a thin walled design R/t>=10 (R=vessel radius, t=wall thickness) the following design formulas for cylindrical shell minimum wall thickness requirement.

Considering circumferential stress:

$$t = \frac{P * Ro}{S * E + 0.4 * P}$$

Considering longitudinal stress:

$$t = \frac{P * Ro}{2 * S * E + 1.4 * P}$$

t=Wall thickness (in.)
P=Design pressure (psi)
Ro=Outside radius (in.)
S=Allowable stress (psi)
E=Weld joint efficiency factor

Similarly the allowable pressure can be calculated using the ASME code and design by rule method. Given a design temperature, allowable stress (from vessel material), vessel radius (from volume) and wall thickness, the following formulas provide the maximum allowable pressure.

Considering circumferential stress:

$$P = \frac{S * E * t}{Ro - 0.4 * t}$$

Considering longitudinal stress:

$$P = \frac{2 * S * E * t}{Ro - 1.4 * t}$$

By way of example, the allowable pressure based on given vessel material and geometry is calculated for a thin walled deep drawn cylindrical aluminum shell.

t=3 mm=0.118 in
Ro=98 mm=3.504 in
S=133.3 MPa=16437.6 psi (based on yield strength of Aluminum alloy at 170 MPa, and a safety factor of normally 1.5 according to ASME code)

### E=1

Allowable pressure based on circumferential stress:

$$P = \frac{16437.6 psi * 1 * 0.188 in}{3.504 in - 0.4 * 0.118 in} = 561.6 psi = 3.9 Mpa$$

Allowable pressure based on longitudinal stress:

$$P = \frac{2 * 16437.6 psi * 1 * 0.188 in}{3.504 in - 0.4 * 0.118 in} = 1163.0 psi = 8.0 Mpa$$

Taking the lowest value from the calculations above gives allowable pressure 3.9 MPa.

Furthermore, there is, as mentioned above, a design safety factor of 1.5 in the calculation. This leads to an allowable pressure PUNT of 3.9 MPa/1.5=2.6 MPa.

Using the correlation of FIG. 2 for a density of D_{MAT-C} a value of the minimum temperature T_{SATMIN} at which the saturation/resaturation process is to be carried of approx. 40° C. for this specific value of D_{MAT} is obtained.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1.-17. (canceled)

18. A method for controlling the magnitude of mechanical forces exerted by a solid ammonia storage material on walls of a container holding the storage material inside its interior volume when the storage material is undergoing saturation/resaturation with ammonia inside said storage container, said method comprising:
a. determining a limit for the mechanical strength of the container in terms of a hydraulic pressure, hereinafter P_{LIMIT}, or a hydraulic force, hereinafter F_{LIMIT}, in its interior volume under which the walls of container do not undergo plastic deformation, or do not undergo deformation of more than 200% of a deformation at a yield point of the container walls;
b. using a given correlation between
i. a temperature for ammonia saturation/resaturation process of the storage material, hereinafter T_{SAT}, and
ii. the hydraulic pressure P_{MAT}, or equivalent mechanical force F_{MAT} generated by the storage material during saturation/resaturation at said temperature T_{SAT},
to identify a minimum temperature, hereinafter T_{SATMIN}, of the saturation/resaturation process where P_{MAT}, or F_{MAT}, exerted by the storage material is kept below the limit for the mechanical strength in terms of P_{LIMIT}, or F_{LIMIT}, of the container by carrying out the saturation/resaturation process at the temperature T_{SAT} fulfilling the condition of T_{SAT}≧T_{SATMIN}.

19. The method according to claim 18 wherein the storage material has a density, hereinafter D_{MAT}, in wherein in the determination of T_{SATMIN}, besides using the correlation between T_{SAT} and P_{MAT}; or F_{MAT}, also a correlation with the density D_{MAT} of the storage material is taken into account, as a higher density D_{MAT} generally leads to higher mechanical forces exerted by the solid ammonia storage material on the walls of the container, where D_{MAT} refers to the density of the ammonia storage material being fully saturated with ammonia.

20. The method according to claim 18 wherein the ammonia storage material is cooled during the saturation/resaturation process by a liquid cooling media having a boiling point, and wherein the saturation/resaturation process at the temperature T_{SAT} fulfills the condition T_{CMBP}≧T_{SAT}≧T_{SATMIN}, where T_{CMBP} is the boiling point of the cooling media.

21. The method according to claim 18 wherein the ammonia storage material is cooled during the saturation/resaturation process by a gaseous cooling media, and wherein the saturation/resaturation process at the temperature T_{SAT} fulfills the condition T_{CMBP}≧T_{SAT}≧T_{SATMIN}, where T_{CMBP} is an upper limit on the temperature at which the saturation/resaturation process is performed cooled by the gaseous cooling media.

22. The method according to claim 20 wherein T_{CMBP} is 100° C.

23. The method according to claim 18 wherein the container has a mechanical strength which enables the container to withstand the pressure generated by desorbed ammonia at 85° C. with a volumetric expansion no greater than 0.1 volume-%.

24. The method according to claim 23, wherein the pressure generated by desorbed ammonia from the storage material at 85° C. is 12 bar.

25. The method according to claim 19 where P_{LIMIT}, or F_{LIMIT}, and subsequently T_{SATMIN} are determined from:
a. having an existing container design available,
b. knowing from the existing design the value of P_{LIMIT}, or F_{LIMIT}, or using (i) standard mechanical engineering practice, (ii) hydraulic pressure measurements, or (iii) mechanical simulations to identity the value of P_{LIMIT}, or F_{LIMIT}, and
c. using the known or identified P_{LIMIT}, or F_{LIMIT}, to determine the loading density D_{MAT} and the saturation/resaturation condition T_{SAT}≧T_{SATMIN}, or T_{CMBP}≧T_{SAT}≧T_{SATMIN}, to prevent P_{MAT}, or F_{MAT}, from exceeding P_{LIMIT}, or F_{LIMIT}.

26. The method according to claim 18 where the procedure of determining T_{SATMIN} includes an experimental mapping procedure in which experimental data points are obtained to establish an empirical relationship or correlation between the dependent variable P_{MAT}, and the independent variable T_{SAT}, said procedure comprising
a. preparing at least one sample of ammonia storage material;
b. carrying out ammonia desorption and resaturation experiments in a sample holder capable of measuring P_{MAT} exerted by the material on the walls of the sample holder when the material is undergoing saturation/re-saturation, said procedure being carried out at different temperature levels T_{SAT};
c. using the experimental data points to generate a function or interpolation formula P_{MAT}=f(T_{SAT}), or F_{MAT}=f(T_{SAT}).

27. The method according to claim 18 where the procedure of determining T_{SATMIN} includes an experimental mapping procedure in which experimental data points are obtained to establish an empirical relationship or correlation between the dependent variable P_{MAT}, or F_{MAT}, and the independent variables T_{SAT} and D_{MAT}, said procedure comprising:
a. preparing at least one sample of ammonia storage material with known density D_{MAT};
b. carrying out ammonia desorption and resaturation experiments in a sample holder capable of measuring P_{MAT} exerted by the material on the walls of the sample holder when it the material is undergoing saturation/re-saturation, said procedure being carried out at different temperature levels T_{SAT};
c. using the experimental data points to generate a function or interpolation formula P_{MAT}=f(T_{SAT}, D_{MAT}), or F_{MAT}=f(T_{SAT}, D_{MAT}) in the case where samples with different densities D_{MAT} are measured.

28. The method according to claim 19 where the procedure of determining T_{SATMIN} is done by creating a relationship between P_{MAT}, or F_{MAT}, and T_{SAT} via computer simulations using parameters describing the ammonia storage material, ammonia itself, and the storage material in saturated form.

29. The method according to claim 19 where the procedure of determining T_{SATMIN} is done by creating a relationship between P_{MAT}, or F_{MAT}, and T_{SAT} and D_{MAT} via computer simulations using parameters describing the ammonia storage material, ammonia itself, and the storage material in saturated form.

30. The method according to claim 18 where the limit for the mechanical strength of the container in terms of the hydraulic pressure P_{LIMIT} or the hydraulic force F_{LIMIT} in its interior volume is the limit under which the walls of container do not undergo deformation of more than 110%, 120%, or 150% of the deformation at the yield point of the container walls.

31. A method of designing a container for accommodating solid ammonia storage material where a process temperature for ammonia saturation/resaturation T_{SAT} and a target density of the storage material, D_{MAT}, are fixed, and the outcome of the design method is a container design capable of withstanding a resulting exerted pressure from the material, P_{MAT}, or force F_{MAT}, upon ammonia saturation/resaturation, the method comprising using a known relation between T_{SAT}, D_{MAT}, and P_{MAT}, or F_{MAT}, to establish a value of P_{MAT}, or F_{MAT}, and use this value for the design of the container such that its mechanical strength measured in terms of a hydraulic-limit parameter P_{LIMIT}, or F_{LIMIT}, under which walls of the container do not undergo plastic deformation, or do not undergo deformation of more than 200% of a deformation at a yield point of the container walls, is equal to or exceeds the value of P_{MAT}, or F_{MAT}.

32. A container filled with a solid ammonia storage material with a storage density, D_{MAT}, capable of desorbing and absorbing/reabsorbing ammonia, said container having a mechanical strength corresponding to a limit-pressure parameter, P_{LIMIT}, or limit-force parameter F_{LIMIT}, at which pressure, or force, inside the container the container does not undergo plastic deformation, or does not undergo deformation of more than 200% of a deformation at a yield point of the container walls, and
said storage material in the container being filled with ammonia by a saturation/re-saturation process in which the saturation/resaturation of the storage material is performed with the storage material inside the container at a process temperature, T_{SAT}, fulfilling the condition T_{SAT}≧T_{SATMIN},
where T_{SATMIN} is a minimum temperature of the saturation/resaturation process where P_{MAT}, or F_{MAT}, exerted by the storage material is kept below the limit for the mechanical strength in terms of P_{LIMIT}, or F_{LIMIT}, of the container.
